(19) United States
(12) Patent Application Publication
(10) Pub. No.: US 2026/0112129 A1
(43) Pub. Date: Apr. 23, 2026

(54) METHOD AND DEVICE FOR MEASURING HUD GHOST IMAGE

(71) Applicant: SOOKMYUNG WOMEN'S UNIVERSITY INDUSTRY-ACADEMIC COOPERATION FOUNDATION, Seoul (KR)

(72) Inventor: Young Ju JEONG, Seoul (KR)

(21) Appl. No.: 19/117,605

(22) PCT Filed: Jul. 6, 2023
(86) PCT No.: PCT/KR2023/009559

§ 371 Date: Apr. 1, 2025

(30) Foreign Application Priority Data
Oct. 17, 2022 (KR) 10-2022-0133555

(51) Int. Cl. G06T 19/00; H04N 5/21

(52) U.S. Cl. CPC G06T 19/006; H04N 5/211

(57) ABSTRACT

An optical characteristic measurement method according to embodiments may comprise the steps of: generating multi-view images, the multi-view images including a left image, a central image, and a right image; displaying the position of a virtual image for the multi-view images; calculating the depth of the position of the virtual image; estimating the depth of the virtual image; matching the depth of the position to the depth of the virtual image; and calibrating errors between the multi-view images on the basis of the matched depth. Additionally, the optical characteristic measurement method may comprise the steps of: generating multi-view images, the multi-view images including a left image, a central image, and a right image; displaying the positions of virtual images for the multi-view images; estimating the depths of the positions of the virtual images; grouping the positions on the basis of the depths; selecting some positions from the grouped positions; and projecting a corrected virtual object on the basis of the selected positions and the depths.

### TECHNICAL FIELD

Embodiments of the present disclosure relate to a method and apparatus for measuring a head up display (HUD) ghost image, and more particularly to a method and device for measuring optical characteristics of three-dimensional (3D) virtual images generated by an augmented reality (AR) device.

### BACKGROUND ART

Augmented reality (AR), which is a field of virtual reality (VR), is a computer graphic technique that makes virtual objects look like objects existing in the original environment by synthesizing the virtual objects or information with the real environment, and is frequently used in digital media.

As augmented reality (AR) shows a combination of actual reality and virtual reality having additional information in real time through one image, augmented reality (AR) is also called mixed reality (MR). A hybrid virtual reality (VR) system that combines the real environment and the virtual environment has been studied and developed with U.S. as a leader since the late 1990s.

For example, augmented reality may be used in remote medical diagnosis, broadcasting, architectural design, manufacturing process management, etc. In addition, as smartphones have become widely popularized, they have entered the full-scale commercialization stage, and various products are being developed in the game and mobile solution industries and education fields.

Meanwhile, a wearable computer is an example of a device of capable of realizing augmented reality (AR) outdoors. In particular, a head mounted display (HMD) that is worn on a user's head enables augmented reality by overlaying computer graphics and text on the actual environment seen by the user in real time. Further, a head up display (HUD) enables augmented reality by displaying various kinds of information for driving a vehicle on the outside of a windshield of the vehicle.

For example, a head-up display can implement augmented reality (AR) by displaying a light source output from the inside of a vehicle to the outside of the windshield in a virtual plane located outside the windshield of the vehicle, thereby allowing the driver to obtain information necessary for driving the vehicle from the virtual plane without moving his or her gaze while driving.

At this time, geometric characteristics including the position of the virtual plane formed by individual augmented reality (AR) devices such as an HMD and an HUD may be determined according to optical characteristics of the individual augmented reality (AR) devices.

Therefore, there is a growing need for a method and apparatus capable of measuring the optical characteristics of signals output from the augmented reality (AR) device.

As a related prior art, there is Korean Patent Publication No. 10-2017-0114375 (entitled “Virtual Reality Content Display Method and Device”, Publication Date: Oct. 16, 2017)

### DISCLOSURE

### Technical Problem

An object of the present disclosure is to provide a method and apparatus or measuring the optical characteristics of virtual images produced by the augmented reality (AR) device.

Another object of the present disclosure is to provide a method and apparatus for calculating a virtual image distance, a look down/up angle of a virtual image, a horizontal/vertical field of view (FOV), a static distortion, a ghosting level, etc. with respect to a user of an augmented reality (AR) device, using the optical characteristics of a virtual image produced by the augmented reality (AR) device.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solutions

In accordance with an aspect of the present disclosure, a method for measuring optical characteristics of an augmented reality (AR) device may include: capturing a test image including a plurality of patterns to be output on a virtual plane by the augmented reality (AR) device using a plurality of cameras arranged around a predetermined measurement reference position; obtaining field of view (FOV) information including information about fields of view (FOVs) of the plurality of cameras and arrangement information including information about arrangement of the plurality of cameras; and calculating coordinates of the plurality of patterns based on the measurement reference position based on the plurality of captured images obtained by the plurality of cameras, the FOV information, and the arrangement information.

Preferably, the at least one camera is a central camera positioned at the measurement reference position, and a left camera and a right camera symmetrically positioned with the measurement reference position therebetween. When a plurality of patterns is horizontally and vertically arranged in one test image, the calculation unit may calculate the coordinates of the plurality of patterns may include calculating the coordinates of a plurality of patterns, using the number of horizontal pixels of a plurality of captured images, the coordinates of a plurality of patterns in the plurality of captured images, the field of view (FOV) of at least one camera included in field of view (FOV) information, and the distance between the left camera and the right camera included in the arrangement information.

In another embodiment, the calculating the coordinates of the plurality of patterns may include: calculating the coordinates of a plurality of patterns, using Equation 1.

$${z}_{ij} = \frac{α}{2 \cdot tan \frac{θ}{2}} \cdot \frac{M}{( {m}_{ij}^{L} - {m}_{ij}^{R} )} \qquad [ Equation 1 ]$$

$${x}_{ij} = {z}_{ij} \cdot tan \frac{θ}{2} ( 2 \cdot \frac{{m}_{ij}^{c}}{M} - 1 )$$

$${y}_{ij} = {z}_{ij} \cdot tan \frac{θ}{2} ( 2 \cdot \frac{{n}_{ij}^{c}}{M} - 1 )$$

In Equation 1, xᵢⱼ, yᵢⱼ, and zᵢⱼ are x-axial, y-axial, and z-axial coordinates of the horizontal i-th and vertical j-th pattern with respect to the measurement reference position, α is the distance between the left camera and the right camera, M is the number of horizontal pixels of a plurality of captured images, θ is the field of view (FOV) of at least one camera,

$${m}_{i j}^{L}$$

is the horizontal coordinate of the horizontal i-th and vertical j-th pattern in the captured image of the left camera,

$${m}_{i j}^{R}$$

is the horizontal coordinate of the horizontal i-th and vertical j-th pattern in the captured image of the right camera, and

$${m}_{i j}^{c}$$

is the horizontal coordinate of the horizontal i-th and vertical j-th pattern in the captured image of the central camera.

In another exemplary embodiment, the calculating step may further include: calculating a virtual image distance between a measurement reference position and a virtual plane, using the coordinates of the measurement reference position and the coordinates of at least one of a plurality of patterns on the virtual plane.

In another embodiment, the calculating step may calculate a virtual image distance, using Equation 2.

$${D}_{VI} = \sqrt{{{x}_{22}}^{2} + {{y}_{22}}^{2} + {{z}_{22}}^{2}} \qquad [ Equation 2 ]$$

In Equation 2, D_{VI} is a virtual image distance, and x₂₂, y₂₂, and z₂₂ are the coordinates of one of a plurality of patterns.

In another exemplary embodiment, the calculating step may further include: calculating a look down/up angle from a measurement reference position to a virtual plane, using the coordinates of the measurement reference position and the coordinates of at least one of a plurality of patterns on the virtual plane.

In another exemplary embodiment, the calculating step may include: calculating look down/up angle, using Equation 3.

$${θ}_{down / up} = {cos}^{- 1} \frac{\sqrt{{{x}_{22}}^{2} + {{z}_{22}}^{2}}}{\sqrt{{{x}_{22}}^{2} + {{y}_{22}}^{2} + {{z}_{22}}^{2}}} \qquad [ Equation 3 ]$$

In Equation 3, θ_{down/up} is a look down/up angle, and x₂₂, y₂₂, and z₂₂ are the coordinates of one of a plurality of patterns.

In another exemplary embodiment, the calculating step may further include: calculating the horizontal field of view (FOV) of a measurement reference position, using the coordinates of the measurement reference position and the coordinates of two patterns positioned at both horizontal ends of a plurality of patterns in a virtual plane.

In another exemplary embodiment, the calculating step may include: calculating a horizontal field of view (FOV), using Equation 4.

$${θ}_{FOV}^{H} = {cos}^{- 1} \frac{{‖ \overline{{P}_{21} O} ‖}^{2} + {‖ \overline{{P}_{23} O} ‖}^{2} - {‖ \overline{{P}_{21} {P}_{23}} ‖}^{2}}{2 \cdot ‖ \overline{{P}_{21} O} ‖ ‖ \overline{{P}_{23} O} ‖} \qquad [ Equation 4 ]$$

In Equation 4,

$${θ}_{F O V}^{H}$$

is a horizontal field of view (FOV), O is the coordinate of a measurement reference position, and P₂₁ and P₂₃ are coordinates of two patterns positioned at both horizontal ends.

In another exemplary embodiment, the calculating step may further include: calculating the virtual field of view (FOV) of a measurement reference position, using the coordinates of the measurement reference position and the coordinates of two patterns positioned at both virtual ends of a plurality of patterns in a virtual plane.

In another exemplary embodiment, the calculating step may include: calculating a virtual field of view (FOV), using Equation 5.

$${θ}_{F O V}^{V} = {cos}^{- 1} \frac{{‖ \overline{{P}_{12} O} ‖}^{2} + {‖ \overline{{P}_{32} O} ‖}^{2} - {‖ \overline{{P}_{12} {P}_{32}} ‖}^{2}}{2 \cdot ‖ \overline{{P}_{12} O} ‖ ‖ \overline{{P}_{32} O} ‖} \qquad [ Equation 5 ]$$

In Equation 5,

$${θ}_{F O V}^{V}$$

is a vertical field of view (FOV), O is the coordinate of a measurement reference position, and P₁₂ and P₃₂ are coordinates of two patterns positioned at both vertical ends.

In another exemplary embodiment, the calculating step may further include calculating a static distortion for each of three axes with respect to a measurement reference position on the basis of the coordinates of a plurality of patterns in a virtual plane.

In another exemplary embodiment, the calculating step may further include: calculating the coordinates of a plurality of ghost patterns corresponding to the coordinates of a plurality of patterns, respectively, on the basis of a plurality of captured images, field of view (FOV) information, and arrangement information, and may further calculate ghosting levels on the basis of the coordinates of the plurality of patterns and the coordinates of the plurality of ghost patterns.

In accordance with another aspect of the present disclosure, a device for for measuring optical characteristics of an augmented reality (AR) device may include: a photographing unit that captures a test image including a plurality of patterns to be output on a virtual plane by the augmented reality (AR) device using a plurality of cameras arranged around a predetermined measurement reference position; an acquisition unit that obtains field of view (FOV) information including information about fields of view (FOVs) of the plurality of cameras and arrangement information including information about arrangement of the plurality of cameras; and a calculation unit that calculates coordinates of the plurality of patterns based on the measurement reference position based on the plurality of captured images obtained by the plurality of cameras, the FOV information, and the arrangement information.

Preferably, the at least one camera is a central camera positioned at the measurement reference position, and a left camera and a right camera symmetrically positioned with the measurement reference position therebetween. When a plurality of patterns is horizontally and vertically arranged in one test image, the calculation unit may calculate the coordinates of the plurality of patterns may include calculating the coordinates of a plurality of patterns, using the number of horizontal pixels of a plurality of captured images, the coordinates of a plurality of patterns in the plurality of captured images, the field of view (FOV) of at least one camera included in field of view (FOV) information, and the distance between the left camera and the right camera included in the arrangement information.

In another embodiment, the calculation unit may calculate the coordinates of a plurality of patterns, using Equation 6.

$${z}_{i j} = \frac{α}{2 \cdot tan \frac{θ}{2}} \cdot \frac{M}{( {m}_{i j}^{L} - {m}_{i j}^{R} )} \qquad [ Equation 6 ]$$

$${x}_{i j} = {z}_{i j} \cdot tan \frac{θ}{2} ( 2 \cdot \frac{{m}_{i j}^{c}}{M} - 1 )$$

$${y}_{i j} = {z}_{i j} \cdot tan \frac{θ}{2} ( 2 \cdot \frac{{n}_{i j}^{c}}{M} - 1 )$$

In Equation 6, xᵢⱼ, yᵢⱼ, and zᵢⱼ are x-axial, y-axial, and z-axial coordinates of the horizontal i-th and vertical j-th pattern with respect to the measurement reference position, α is the distance between the left camera and the right camera, M is the number of horizontal pixels of a plurality of captured images, θ is the field of view (FOV) of at least one camera,

$${m}_{i j}^{L}$$

is the horizontal coordinate of the horizontal i-th and vertical j-th pattern in the captured image of the left camera,

$${m}_{i j}^{R}$$

is the horizontal coordinate of the horizontal i-th and vertical j-th pattern in the captured image of the right camera, and

$${m}_{i j}^{c}$$

is the horizontal coordinate of the horizontal i-th and vertical j-th pattern in the captured image of the central camera.

In another exemplary embodiment, the calculation unit may calculate a virtual image distance between a measurement reference position and a virtual plane, using the coordinates of the measurement reference position and the coordinates of at least one of a plurality of patterns on the virtual plane.

In another embodiment, the calculation unit may calculate a virtual image distance, using Equation 7.

$${D}_{V I} = \sqrt{{{x}_{22}}^{2} + {{y}_{22}}^{2} + {{z}_{22}}^{2}} \qquad [ Equation 7 ]$$

In Equation 7, D_{VI} is a virtual image distance, and x₂₂, y₂₂, and z₂₂ are the coordinates of one of a plurality of patterns.

In another exemplary embodiment, the calculation unit may calculate a look down/up angle from a measurement reference position to a virtual plane, using the coordinates of the measurement reference position and the coordinates of at least one of a plurality of patterns on the virtual plane.

In another exemplary embodiment, the calculation unit may calculate look down/up angle, using Equation 8.

$${θ}_{d o w n / u p} = {cos}^{- 1} \frac{\sqrt{{{x}_{22}}^{2} + {{z}_{22}}^{2}}}{\sqrt{{{x}_{22}}^{2} + {{y}_{22}}^{2} + {{z}_{22}}^{2}}} \qquad [ Equation 8 ]$$

In Equation 8, θ_{down/up} is a look down/up angle, and x₂₂, y₂₂, and z₂₂ are the coordinates of one of a plurality of patterns.

In another exemplary embodiment, the calculation unit may calculate the horizontal field of view (FOV) of a measurement reference position, using the coordinates of the measurement reference position and the coordinates of two patterns positioned at both horizontal ends of a plurality of patterns in a virtual plane.

In another exemplary embodiment, the calculation unit may calculate a horizontal field of view (FOV), using Equation 9.

$${θ}_{F O V}^{H} = {cos}^{- 1} \frac{{‖ \overline{{P}_{21} O} ‖}^{2} + {‖ \overline{{P}_{23} O} ‖}^{2} - {‖ \overline{{P}_{21} {P}_{23}} ‖}^{2}}{2 \cdot ‖ \overline{{P}_{21} O} ‖ ‖ \overline{{P}_{23} O} ‖} \qquad [ Equation 9 ]$$

In Equation 9,

$${θ}_{F O V}^{H}$$

is a horizontal field of view (FOV), O is the coordinate of a measurement reference position, and P₂₁ and P₂₃ are coordinates of two patterns positioned at both horizontal ends.

In another exemplary embodiment, the calculation unit may calculate the virtual field of view (FOV) of a measurement reference position, using the coordinates of the measurement reference position and the coordinates of two patterns positioned at both virtual ends of a plurality of patterns in a virtual plane.

In another exemplary embodiment, the calculation unit may calculate a virtual field of view (FOV), using Equation 5.

$${θ}_{F O V}^{V} = {cos}^{- 1} \frac{{‖ \overline{{P}_{12} O} ‖}^{2} + {‖ \overline{{P}_{32} O} ‖}^{2} - {‖ \overline{{P}_{12} {P}_{32}} ‖}^{2}}{2 \cdot ‖ \overline{{P}_{12} O} ‖ ‖ \overline{{P}_{32} O} ‖} \qquad [ Equation 5 ]$$

In Equation 5,

$${θ}_{F O V}^{V}$$

is a vertical field of view (FOV), O is the coordinate of a measurement reference position, and P₁₂ and P₃₂ are coordinates of two patterns positioned at both vertical ends.

In another exemplary embodiment, the calculating step may further include calculating a static distortion for each of three axes with respect to a measurement reference position on the basis of the coordinates of a plurality of patterns in a virtual plane.

In another exemplary embodiment, the calculating step may further include: calculating the coordinates of a plurality of ghost patterns corresponding to the coordinates of a plurality of patterns, respectively, on the basis of a plurality of captured images, field of view (FOV) information, and arrangement information, and may further calculate ghosting levels on the basis of the coordinates of the plurality of patterns and the coordinates of the plurality of ghost patterns.

### Advantageous Effects

As is apparent from the above description, the method and apparatus for measuring the HUD ghost image according to the embodiments of the present disclosure may easily measure optical characteristics of virtual images produced by the augmented reality (AR) device, using a plurality of cameras.

The method and apparatus for measuring the HUD ghost image according to the embodiments of the present disclosure may calculate a virtual image distance, a look down/up angle of a virtual image, a horizontal/vertical field of view (FOV), a static distortion, a ghosting level, etc. with respect to a user of the augmented reality (AR) device, using optical characteristics of a virtual image produced by the augmented reality (AR) device.

### DESCRIPTION OF DRAWINGS

FIG. 1 is a flowchart showing a method for measuring optical characteristics of an augmented reality device according to an exemplary embodiment of the present disclosure.

FIG. 2 is a flowchart showing a method for calculating a virtual image distance according to an exemplary embodiment of the present disclosure.

FIG. 3 is a flowchart showing a method for calculating a look down/up angle according to an exemplary embodiment of the present disclosure.

FIG. 4 is a flowchart showing a method for calculating a horizontal field of view (FOV) according to an exemplary embodiment of the present disclosure.

FIG. 5 is a flowchart showing a method of calculating a vertical field of view (FOV) according to an exemplary embodiment of the present disclosure.

FIG. 6 is a flowchart showing a method of calculating static distortion according to an exemplary embodiment of the present disclosure.

FIG. 7 is a flowchart showing a method of calculating a ghosting level according to an exemplary embodiment of the present disclosure.

FIG. 8 is a block diagram showing an apparatus for measuring optical characteristics of the augmented reality (AR) device according to an exemplary embodiment of the present disclosure.

FIGS. 9A and 9B are diagrams for explaining an environment for measuring optical characteristics of the augmented reality (AR) device according to an exemplary embodiment of the present disclosure.

FIG. 10 is a diagram for explaining the result of capturing (photographing) a test image in a virtual plane using at least one camera according to an exemplary embodiment of the present disclosure.

FIGS. 11A and 11B are diagrams for explaining coordinates of a plurality of patterns included in a captured image using at least one camera according to an exemplary embodiment of the present disclosure.

FIGS. 12A and 12B are diagrams for explaining a method for calculating coordinates of a plurality of patterns according to an exemplary embodiment of the present disclosure.

FIG. 13 is a diagram for explaining a method for calculating a virtual image distance according to an exemplary embodiment of the present disclosure.

FIGS. 14A and 14B are diagrams for explaining a method for calculating a look down/up angle according to an exemplary embodiment of the present disclosure.

FIGS. 15A and 15B are diagrams for explaining a method of calculating a horizontal field of view (FOV) and a vertical field of view (FOV) of a plurality of patterns according to an exemplary embodiment of the present disclosure.

FIG. 16 is a diagram for explaining a method for calculating static distortion according to an exemplary embodiment of the present disclosure.

FIG. 17 is a diagram for explaining a method of calculating a ghosting level according to an exemplary embodiment of the present disclosure.

FIG. 18 shows a measurement configuration for image quality characteristics of a virtual image type 3D display such as a 3D HUD according to the embodiments of the present disclosure.

FIG. 19 shows a measurement method for a ghost image according to the embodiments of the present disclosure.

FIG. 20 shows a test image with nine measurement points and three corresponding images captured by LMDs according to the embodiments of the present disclosure.

FIG. 21 shows a method for obtaining a ghost level for a ghost image according to the embodiments of the present disclosure.

FIG. 22 is a flowchart illustrating an optical measurement method according to the embodiments of the present disclosure.

FIG. 23 is a block diagram illustrating an optical measurement device according to embodiments of the present disclosure.

### BEST MODE

The present disclosure may be modified in various ways and implemented by various exemplary embodiments, so that specific exemplary embodiments are shown in the drawings and will be described in detail herein. However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings.

Terms used in the specification, ‘first’, ‘second’, ‘A’, ‘B’, etc., may be used to describe various components, but the components are not to be construed as being limited to the terms. The terms are used only to distinguish one component from another component. For example, the ‘first’ component may be named the ‘second’ component, and vice versa, without departing from the scope of the present disclosure. The term ‘and/or’ includes a combination of a plurality of relevant items or any one of a plurality of relevant terms.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element intervening therebetween.

Terms used in the present specification are used only to describe specific exemplary embodiments rather than limiting the present disclosure. Singular forms are intended to include plural forms unless the context clearly indicates otherwise. It will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms have the same meaning as those that are understood by those who are skilled in the art. It will be further understood that terms such as terms defined in common dictionaries should be interpreted as having a meaning that is consistent with their meaning in the context of this specification and the relevant art and will not be interpreted in an idealized or overly formal sense unless expressly so defined herein.

Hereinafter, a preferred embodiment according to the present disclosure will be described in detail with reference to the accompanying drawings.

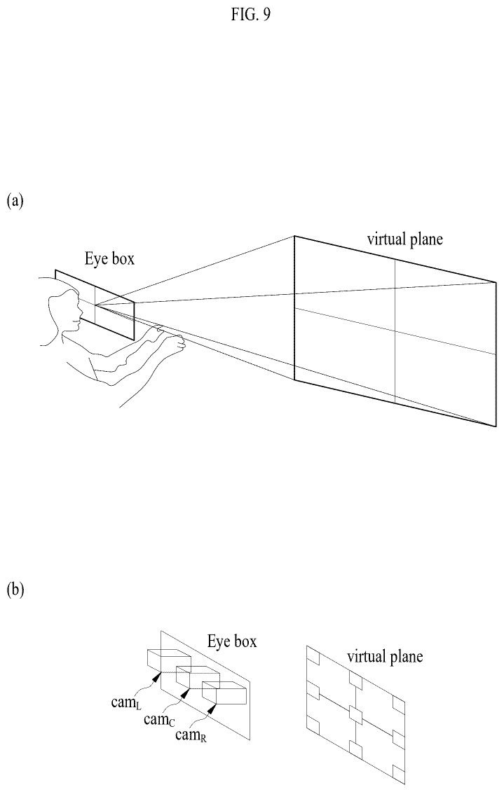

The present disclosure relates to a method and apparatus for measuring optical characteristics of an augmented reality device and measurement may be performed under the following environments. For example, referring to FIG. 9A, the eyes of a user may be positioned in an eye box and a virtual plane output by a virtual reality (VR) device may be formed outside a transparent or translucent screen (e.g., the windshield of a vehicle). In this case, the user can see the entire virtual plane by moving only the eyes. Further, referring to FIG. 9B, a plurality of cameras may be disposed around a measurement reference position in an eye box. In more detail, cam_{C} may be disposed at the measurement reference position, and cam_{L} and cam_{R} may be disposed at symmetric positions at both sides thereof. Meanwhile, a plurality of patterns may be horizontally and vertically arranged (e.g., 3×3) in a test image.

However, it should be noted that the present disclosure is not limited to being implemented only in this environment and may be implemented in various different environments. For example, the position and size of the eye box, the number and arrangement of cameras, the number and arrangement of patterns included in the test image, etc. may depend on the measurement environment.

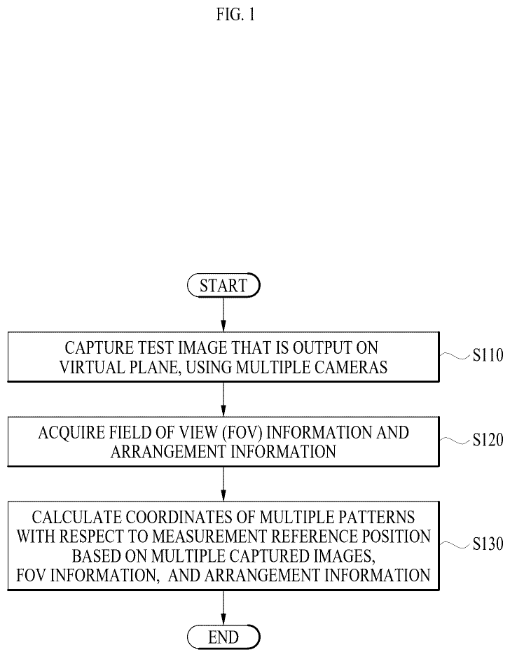

FIG. 1 is a flowchart showing a method for measuring optical characteristics of the augmented reality (AR) device according to an exemplary embodiment of the present disclosure.

In operation S110, an apparatus for measuring optical characteristics captures (photographs) a test image including a plurality of patterns that is output in a virtual plane by the augmented reality (AR) device, using at least one camera disposed around a predetermined measurement reference position.

For example, referring to FIG. 9B, one camera may be disposed at a measurement reference position at the center of the eye box, and the other cameras may be symmetrically disposed to face the front at the same heights at both sides thereof.

In this case, the apparatus for measuring optical characteristics is connected to a plurality of cameras by wire or wirelessly, and may thus transmit an instruction to capture a test image on the virtual plane.

In operation S120, the apparatus for measuring optical characteristics acquires field of view (FOV) information including information about the field of view (FOV) of the at least one camera, and arrangement information including information about the arrangement of the at least one camera.

For example, the apparatus for measuring optical characteristics may acquire field of view (FOV) information and arrangement information by receiving information of the field of view (FOV) of a camera and information about the arrangement of cameras from a user. Preferably, the information about the field of view (FOV) of the camera may be a horizontal field of view (FOV) and the information about the arrangement of cameras may be the distance between cameras symmetrically disposed at both sides of the measurement reference position.

Finally, in operation S130, the apparatus for measuring optical characteristics calculates the coordinates of a plurality of patterns with respect to the measurement reference position on the basis of a plurality of images captured by the at least one camera, field of view (FOV) information, and arrangement information.

In this case, the apparatus for measuring optical characteristics may calculate 3D coordinates of a plurality of patterns in a virtual plane having the measurement reference position as the origin (0, 0, 0), using information about the sizes of a plurality of captured images, information about the coordinates of a plurality of patterns included in the plurality of captured images, information about the field of view (FOV) of at least one camera, and information about the arrangement of the at least one camera.

Meanwhile, a detailed method of calculating the coordinates of the plurality of patterns will be described in detail in the following exemplary embodiment.

In another exemplary embodiment, when the at least one camera includes a central camera positioned at the measurement reference position, and a left camera and a right camera symmetrically positioned with the measurement reference position therebetween and when a plurality of patterns is horizontally and vertically arranged in one test image, the apparatus for measuring optical characteristics may calculate the coordinates of a plurality of patterns, using the number of horizontal pixels of a plurality of captured images, the coordinates of a plurality of patterns in the plurality of captured images, the field of view (FOV) of the at least one camera included in field of view (FOV) information, and the distance between the left camera and the right camera included in the camera arrangement information.

For example, referring to FIG. 9B, at least one camera may be a central camera (cam_{C}) positioned at the measurement reference position, and a left camera (cam_{L}) and a right camera (cam_{R}) symmetrically positioned with the measurement reference position therebetween. Further, nine patterns may be horizontally and vertically arranged in a test image.

In this case, the apparatus for measuring optical characteristics may calculate the 3D coordinates of each of the nine patterns on the virtual plane having the measurement reference position as the origin (0, 0, 0), using the number of horizontal pixels of a plurality of captured images, the coordinates of a plurality of patterns in the plurality of captured images, the field of view (FOV) of the at least one camera included in field of view (FOV) information, and the distance between the left camera and the right camera included in the camera arrangement information.

In another exemplary embodiment, the apparatus for measuring optical characteristics may calculate the coordinates of a plurality of patterns, using Equation 1.

$${z}_{ij} = \frac{α}{2 \cdot tan \frac{θ}{2}} \cdot \frac{M}{( {m}_{ij}^{L} - {m}_{ij}^{R} )} \qquad [ Equation 1 ]$$

$${x}_{ij} = {z}_{ij} \cdot tan \frac{θ}{2} ( 2 \cdot \frac{{m}_{ij}^{c}}{M} - 1 )$$

$${y}_{ij} = {z}_{ij} \cdot tan \frac{θ}{2} ( 2 \cdot \frac{{n}_{ij}^{c}}{M} - 1 )$$

In Equation 1, xᵢⱼ, yᵢⱼ, and zᵢⱼ are X-axial, Y-axial, and Z-axial coordinates of the horizontal i-th and vertical j-th pattern with respect to the measurement reference position, a is the distance between the left camera and the right camera, M is the number of horizontal pixels of a plurality of captured images, θ is the field of view (FOV) of at least one camera,

$${m}_{i j}^{L}$$

is the horizontal coordinate of the horizontal i-th and vertical j-th pattern in the captured image of the left camera,

$${m}_{i j}^{R}$$

is the horizontal coordinate of the horizontal i-th and vertical j-th pattern in the captured image of the right camera, and

$${m}_{i j}^{c}$$

is the horizontal coordinate of the horizontal i-th and vertical j-th pattern in the captured image of the central camera.

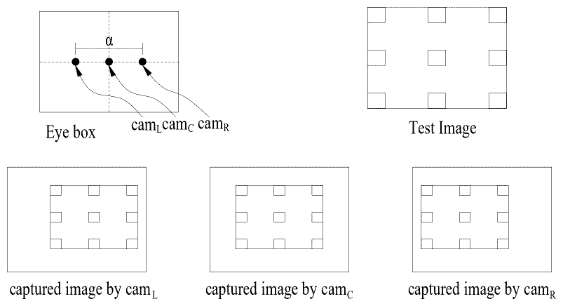

In this case, referring to FIG. 10, a central camera (cam_{C}) may be disposed at the measurement reference position that is the center of an eye box, and left camera (cam_{L}) and a right camera (cam_{R}) may be disposed with a distance (α) therebetween. Further, the apparatus for measuring optical characteristics may capture a test image in a virtual plane, using the central camera (cam_{C}), the left camera (cam_{L}), and the right camera (cam_{R}) that are disposed to face the front. As a result, the test image of the captured image by the left camera (cam_{L}) may be biased to the right, the test image of the captured image by the central camera (cam_{C}) may not be biased, and the test image of the captured image by the right camera (cam_{R}) may be biased to the left.

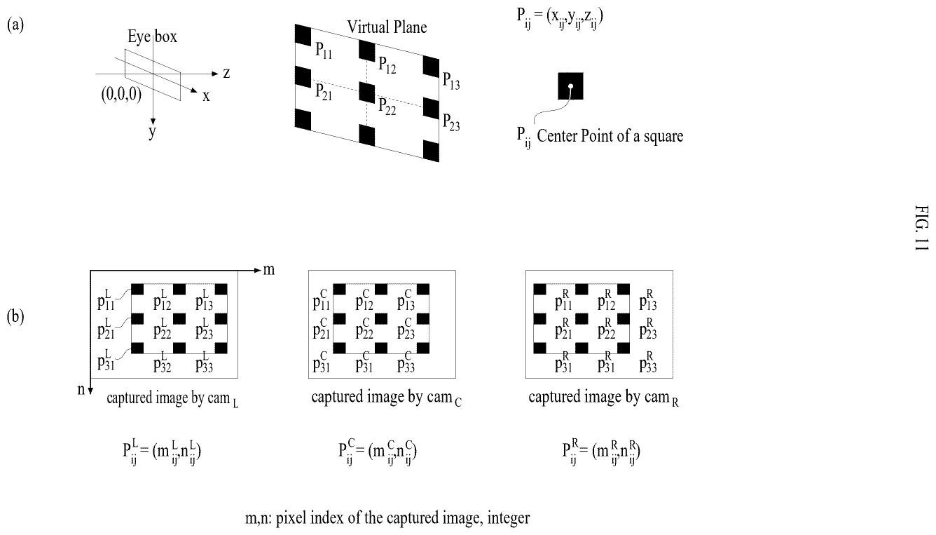

Meanwhile, referring to FIG. 11A, the 3D coordinates of nine patterns shown in a virtual plane may be expressed by Pᵢⱼ=(xᵢⱼ, yᵢⱼ, zᵢⱼ), where ‘i’ is the horizontal index (where i=1, 2, 3) of the patterns and ‘j’ is the vertical index 0=1, 2, 3) of the patterns. That is, Pᵢⱼ may be the 3D coordinates of the center of the horizontal i-th and vertical j-th pattern.

Further, referring FIG. 11B, the pixel coordinates of nine patterns shown in a captured image may be expressed as

$${P}_{i j}^{L} , {P}_{i j}^{C} , and {P}_{i j}^{R} ,$$

and may mean the coordinates of patterns shown in the captured image of each of the left camera (cam_{L}), the central camera (cam_{C}), and the right camera (cam_{R}). In this case,

$${P}_{ij}^{L} = ( {m}_{i j}^{L} , {n}_{i j}^{L} ) , {P}_{ij}^{c} = ( {m}_{i j}^{C} , {m}_{i j}^{C} ) , and {P}_{ij}^{R} = ( {m}_{i j}^{R} , {n}_{i j}^{R} ) .$$

In this case,

$${P}_{i j}^{L} , {P}_{i j}^{C} , and {P}_{ij}^{R}$$

may be pixel coordinates of the center of the horizontal i-th and vertical j-th pattern.

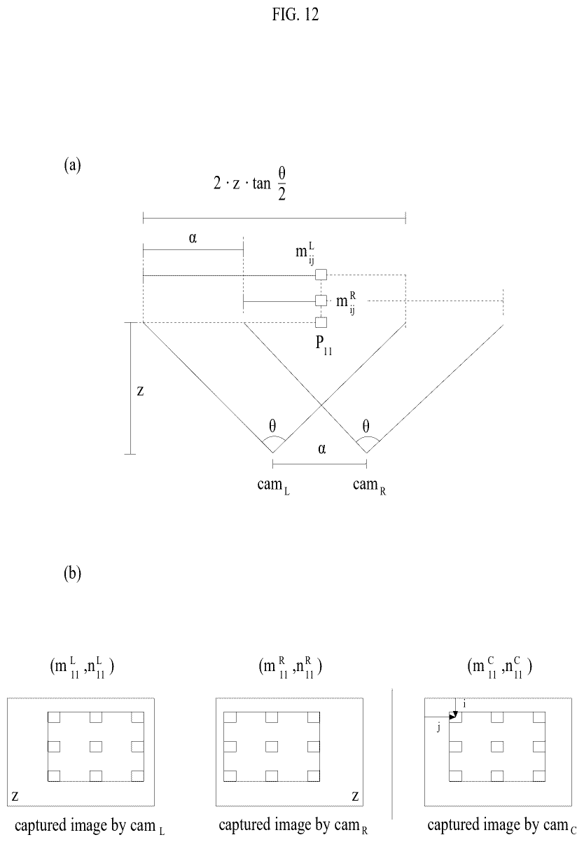

Meanwhile, referring to FIG. 12A, it can be seen that a proportional relationship such as Equation 2 below is established.

$$\frac{α}{2 \times z \times tan ( θ / 2 )} = \frac{{m}_{i j}^{L} - {m}_{i j}^{R}}{M} \qquad [ Equation 2 ]$$

In Equation 2, ‘z’ is the z-axial distance from a measurement reference position to a virtual plane, θ is the field of view of a camera, a is the distance between a left camera and a right camera,

$${m}_{i j}^{L}$$

is the horizontal coordinate of a horizontal i-th and vertical j-th pattern in the captured image of the left camera,

$${m}_{i j}^{R}$$

is the horizontal coordinate of a horizontal i-th and vertical j-th pattern in the captured image of the right camera, and M is the number of horizontal pixels of a captured image.

In this case, it is apparent that Equation 1 may be obtained by rearranging Equation 2.

For example, referring to FIG. 12B, the apparatus for measuring optical characteristics may calculate x₁₁, y₁₁, and z₁₁ through Equation 1, using the result of taking pictures using the central camera (cam_{C}), the left camera (cam_{L}), and the right camera (cam_{R}) for the same pattern (i=1 and j=1).

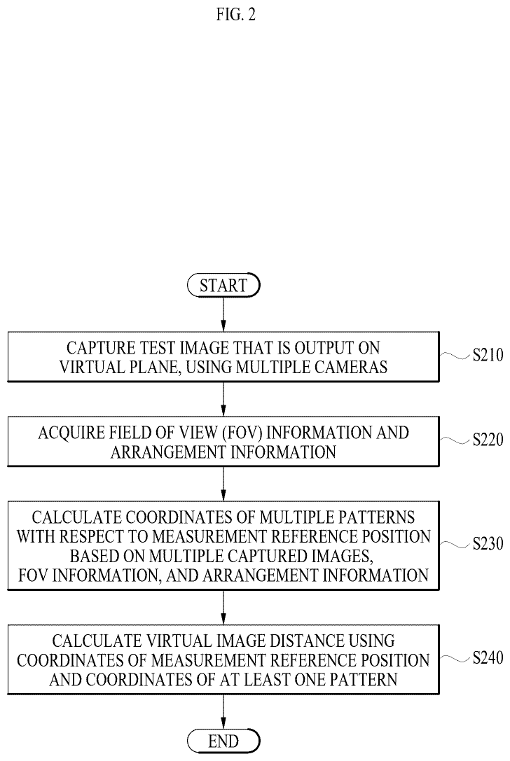

FIG. 2 is a flowchart showing a method of calculating a virtual image distance according to an exemplary embodiment of the present disclosure.

In operation S210, the apparatus for measuring optical characteristics captures a test image including a plurality of patterns that is output in a virtual plane by the augmented reality (AR) device, using at least one camera disposed around a predetermined measurement reference position.

In operation S220, the apparatus for measuring optical characteristics acquires field of view (FOV) information including information about the field of view (FOV) of the at least one camera, and the arrangement information including information about the arrangement of the at least one camera.

In operation S230, the apparatus for measuring optical characteristics calculates the coordinates of a plurality of patterns with respect to the measurement reference position on the basis of a plurality of images captured by the at least one camera, field of view (FOV) information, and the camera arrangement information.

Finally, in operation S240, the apparatus for measuring optical characteristics calculates a virtual image distance between the measurement reference position and the virtual plane, using the coordinates of the measurement reference position and the coordinates of at least one of the plurality of patterns.

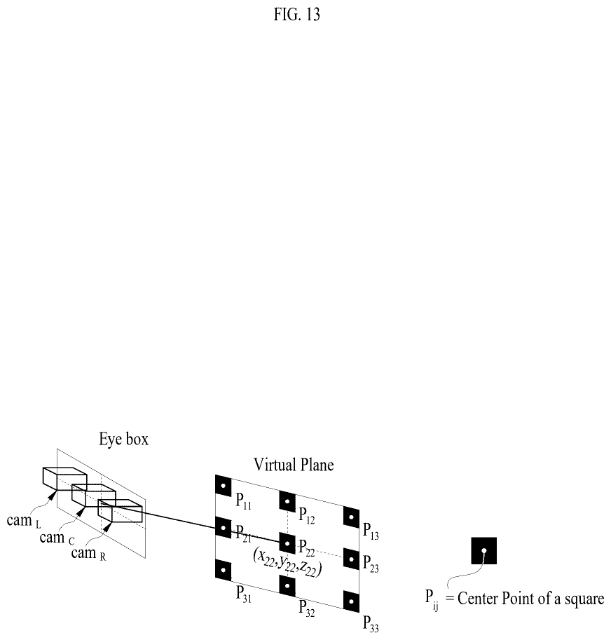

For example, referring to FIG. 13, the apparatus for measuring optical characteristics may calculate a virtual image distance by calculating the distance from (0, 0, 0), which is the measurement reference position to the coordinates (x₂₂, y₂₂, z₂₂) of P₂₂.

In another exemplary embodiment, the apparatus for measuring optical characteristics may calculate a virtual image distance, using Equation 3.

$${D}_{V I} = \sqrt{{x}_{22}^{2} + {y}_{22}^{2} + {z}_{22}^{2}} \qquad [ Equation 3 ]$$

In Equation 3, D_{VI} is a virtual image distance, and x₂₂, y₂₂, z₂₂ are three-dimensional (3D) coordinates of a pattern where i=2 and j=2.

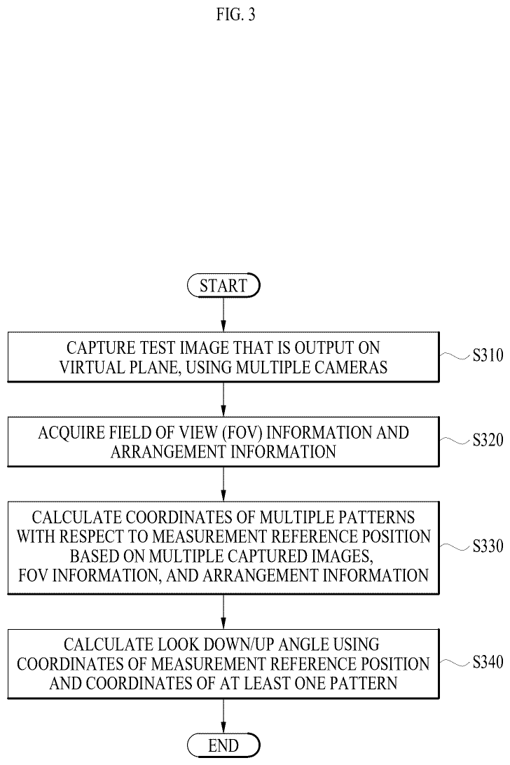

FIG. 3 is a flowchart showing a method of calculating a look down/up angle according to an exemplary embodiment of the present disclosure.

In operation S310, the apparatus for measuring optical characteristics captures a test image including a plurality of patterns that is output in a virtual plane by the augmented reality (AR) device, using at least one camera disposed around a predetermined measurement reference position.

In operation S320, the apparatus for measuring optical characteristics acquires field of view (FOV) information including information about the field of view (FOV) of the at least one camera, and arrangement information including information about the arrangement of the at least one camera.

In operation S330, the apparatus for measuring optical characteristics calculates the coordinates of a plurality of patterns with respect to the measurement reference position on the basis of a plurality of images captured by the at least one camera, field of view (FOV) information, and the arrangement information.

Finally, in operation S340, the apparatus for measuring optical characteristics calculates a look down/up angle to the virtual plane from the measurement reference position, using the coordinates of the measurement reference position and the coordinates of at least one of the plurality of patterns.

The look down/up angle, which is the angle showing the height difference between an eye box and a virtual plane, shows whether a user looks up or looks down the virtual plane.

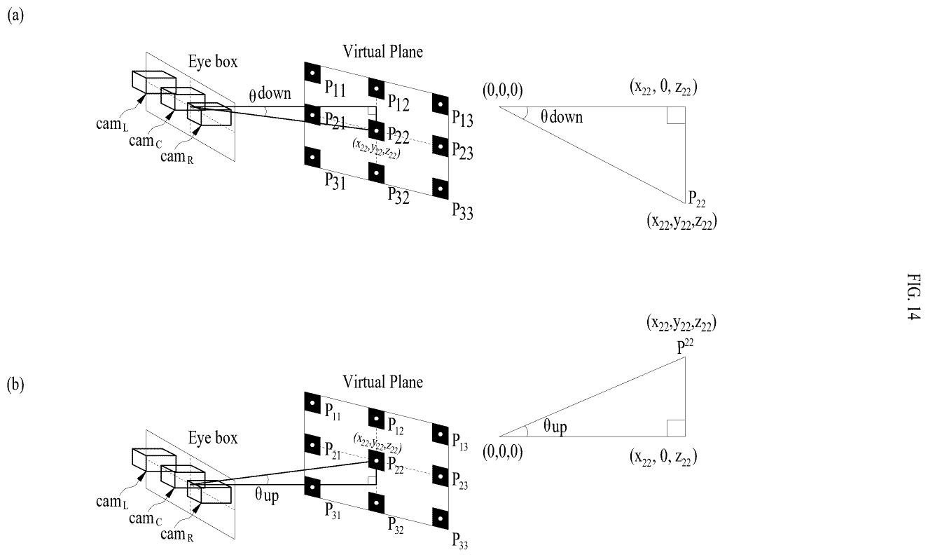

For example, when the coordinates (x₂₂, y₂₂, z₂₂) of P₂₂ are calculated with respect to (0, 0, 0), which is the measurement reference position where the user's eyes are positioned, it may be a looking-down situation if y₂₂<0, as shown in FIG. 14A, and it may be a looking-up situation if y₂₂>0, as shown in FIG. 14B.

In another exemplary embodiment, the apparatus for measuring optical characteristics may calculate look down/up angle, using Equation 4.

$${θ}_{d own / up} = {cos}^{- 1} \frac{\sqrt{{x}_{22}^{2} + {z}_{22}^{2}}}{\sqrt{{x}_{22}^{2} + {y}_{22}^{2} + {z}_{22}^{2}}} \qquad [ Equation 4 ]$$

In Equation 4, θ_{down/up} is a lookdown/up angle, and x₂₂, y₂₂, z₂₂ are three-dimensional (3D) coordinates of a pattern where i=2 and j=2.

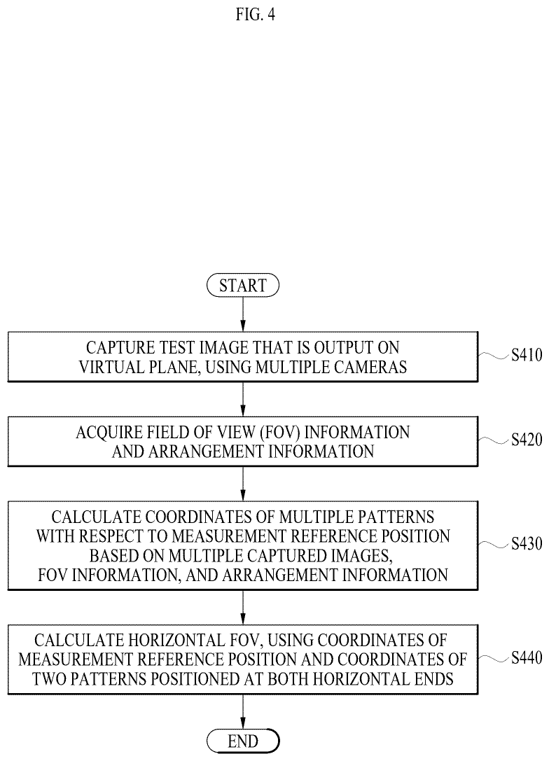

FIG. 4 is a flowchart showing a method of calculating a horizontal field of view (FOV) according to an exemplary embodiment of the present disclosure.

In operation S410, the apparatus for measuring optical characteristics captures a test image including a plurality of patterns that is output in a virtual plane by the augmented reality (AR) device, using at least one camera disposed around a predetermined measurement reference position.

In operation S420, the apparatus for measuring optical characteristics acquires field of view (FOV) information including information about the field of view (FOV) of the at least one camera, and the arrangement information including information about the arrangement of the at least one camera.

In operation S430, the apparatus for measuring optical characteristics calculates the coordinates of a plurality of patterns with respect to the measurement reference position on the basis of a plurality of images captured by the at least one camera, field of view information (FOV) and the arrangement information.

Finally, in operation S440, the apparatus for measuring optical characteristics calculates the horizontal field of view (FOV) of the measurement reference position, using the coordinates of the measurement reference position and the coordinates of two patterns positioned at both horizontal ends of the plurality of patterns on the virtual plane.

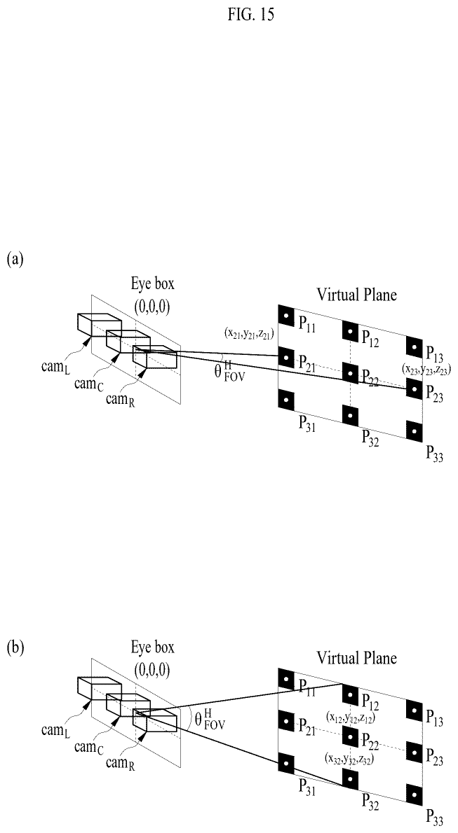

For example, referring to FIG. 15A, the apparatus for measuring optical characteristics may calculate an angle ∠P₂₁OP₂₃ as a horizontal field of view (FOV), using the 3D coordinates O=(0, 0, 0) of the measurement reference position and the 3D coordinates of two patterns P21=(x₂₁, y₂₁, z₂₁) and P23=(x₂₃, y₂₃, z₂₃) positioned at both horizontal ends of the plurality of patterns on the virtual plane.

In another exemplary embodiment, the apparatus for measuring optical characteristics may calculate a horizontal field of view (FOV), using Equation 5.

$${θ}_{F O V}^{H} = {cos}^{- 1} \frac{{‖ \overline{{P}_{21} O} ‖}^{2} + {‖ \overline{{P}_{23} O} ‖}^{2} - {‖ \overline{{P}_{21} {P}_{23}} ‖}^{2}}{2 \cdot ‖ \overline{{P}_{21} O} ‖ ‖ \overline{{P}_{23} O} ‖} \qquad [ Equation 5 ]$$

In Equation 5,

$${θ}_{F O V}^{H}$$

is a horizontal field of view (FOV), O is the coordinate of a measurement reference position, and P₂₁ and P₂₃ are coordinates of two patterns positioned at both horizontal ends of a plurality of patterns.

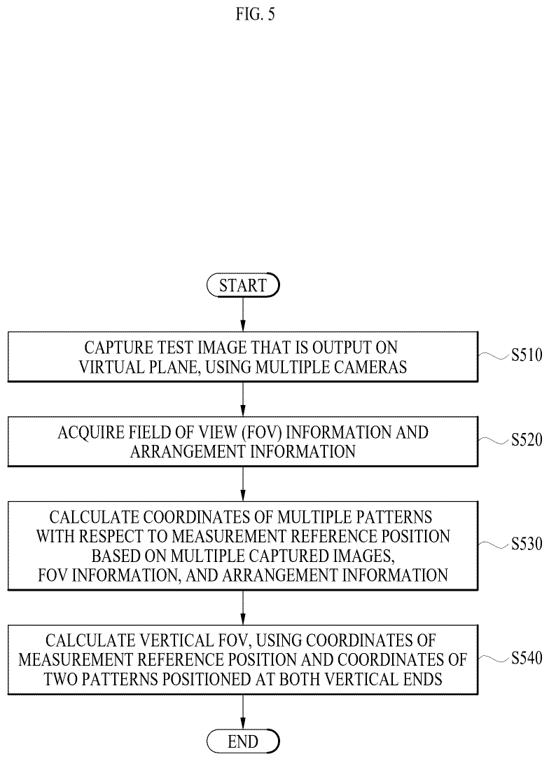

FIG. 5 is a flowchart showing a method of calculating a vertical field of view (FOV) according to an exemplary embodiment of the present disclosure.

In operation S510, the apparatus for measuring optical characteristics captures a test image including a plurality of patterns that is output in a virtual plane by the augmented reality (AR) device, using at least one camera disposed around a predetermined measurement reference position.

In operation S520, the apparatus for measuring optical characteristics acquires field of view (FOV) information including information about the field of view (FOV) of the at least one camera, and the arrangement information including information about the arrangement of the plurality of cameras.

In operation S530, the apparatus for measuring optical characteristics calculates the coordinates of a plurality of patterns with respect to the measurement reference position on the basis of a plurality of images captured by the at least one camera, field of view (FOV) information, and the arrangement information.

Finally, in operation S540, the apparatus for measuring optical characteristics calculates the vertical field of view (FOV) of the measurement reference position, using the coordinates of the measurement reference position and the coordinates of two patterns positioned at both vertical ends of the plurality of patterns on the virtual plane.

For example, referring to FIG. 15B, the apparatus for measuring optical characteristics may calculate an angle ∠P₁₂OP₃₂ as a vertical field of view (FOV), using the 3D coordinates O=(0, 0, 0) of the measurement reference position and the 3D coordinates of two patterns P₁₂=(x₁₂, y₁₂, z₁₂) and P₃₂=(x₃₂, y₃₂, z₃₂) positioned at both vertical ends of the plurality of patterns on the virtual plane.

In another exemplary embodiment, the apparatus for measuring optical characteristics may calculate a vertical field of view (FOV), using Equation 6.

$${θ}_{F O V}^{V} = {cos}^{- 1} \frac{{‖ \overline{{P}_{12} O} ‖}^{2} + {‖ \overline{{P}_{32} O} ‖}^{2} - {‖ \overline{{P}_{12} {P}_{32}} ‖}^{2}}{2 \cdot ‖ \overline{{P}_{12} O} ‖ + ‖ \overline{{P}_{32} O} ‖} \qquad [ Equation 6 ]$$

In Equation 6,

$${θ}_{F O V}^{V}$$

is a vertical field of view (FOV), O is the coordinate of a measurement reference position, and P12 and P32 are coordinates of two patterns positioned at both vertical ends.

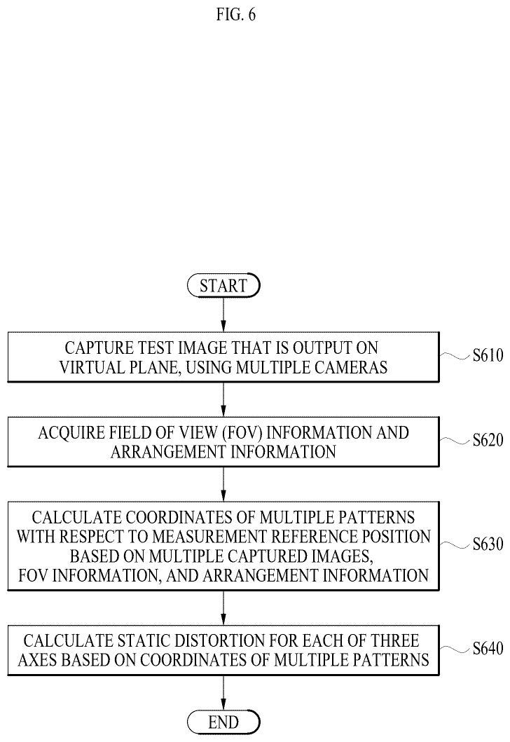

FIG. 6 is a flowchart showing a method of calculating static distortion according to an exemplary embodiment of the present disclosure.

In operation S610, the apparatus for measuring optical characteristics captures a test image including a plurality of patterns that is output in a virtual plane by the augmented reality (AR) device, using at least one camera disposed around a predetermined measurement reference position.

In operation S620, the apparatus for measuring optical characteristics acquires field of view (FOV) information including information about the field of view (FOV) of the at least one camera, and the arrangement information including information about the arrangement of the at least one camera.

In operation S630, the apparatus for measuring optical characteristics calculates the coordinates of a plurality of patterns with respect to the measurement reference position on the basis of a plurality of images captured by the at least one camera, field of view (FOV) information, and arrangement information.

Finally, in operation S640, the apparatus for measuring optical characteristics calculates a static distortion for each of three axes with respect to the measurement reference position on the basis of the coordinates of the plurality of patterns on the virtual plane.

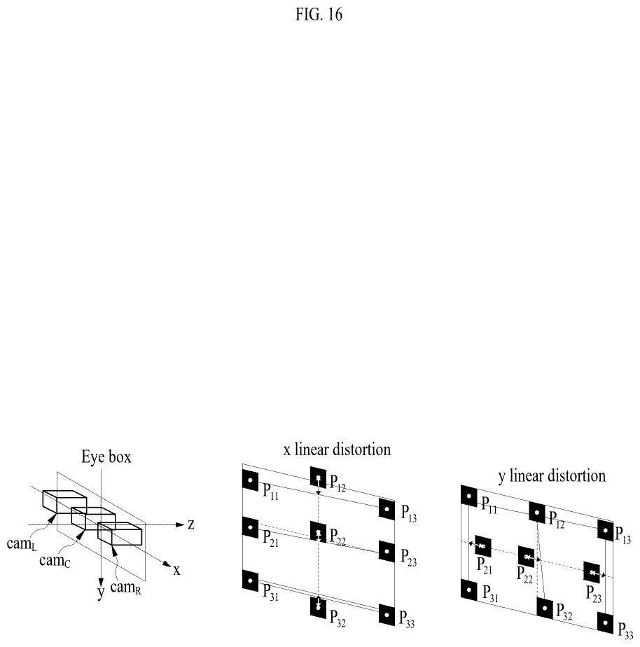

In this case, referring to FIG. 16, the static distortion, which is induced by projection of a virtual reality (VR) device, represents the deviation degree of 3D coordinates of a plurality of patterns from a line corresponding to each of three axes (x, y, z).

Meanwhile, the apparatus for measuring optical characteristics may calculate the static distortion for each of three axes, using Equation 7.

$${DT}_{Linearity}^{x} = \frac{{\sum }_{i = 1}^{3} \vert {x}_{11} + {x}_{i 3} - 2 {x}_{i 2} \vert}{3} \qquad [ Equation 7 ]$$

$${DT}_{Linearity}^{y} = \frac{{\sum }_{i = 1}^{3} \vert {y}_{1 i} + {y}_{3 i} - 2 {y}_{2 i} \vert}{3}$$

$${DT}_{Linearity}^{z} = \frac{{\sum }_{i = 1}^{3} \vert {z}_{1 i} + {z}_{3 i} - 2 {z}_{2 i} \vert}{6} + \frac{{\sum }_{i = 1}^{3} \vert {z}_{i 1} + {z}_{i 3} - 2 {z}_{i 2} \vert}{6}$$

In Equation 7,

$$D {T}_{L i n e a r i t y}^{x} , D {T}_{Linearity}^{y} , and {DT}_{L i n e a r i t y}^{z}$$

are linear distortion values from x, y, and z axes, respectively, and x_{ab}, y_{ab}, and z_{ab} are x, y, and z coordinates of the horizontal a-th (a=1, 2, 3) and vertical b-th (b=1, 2, 3) pattern, respectively.

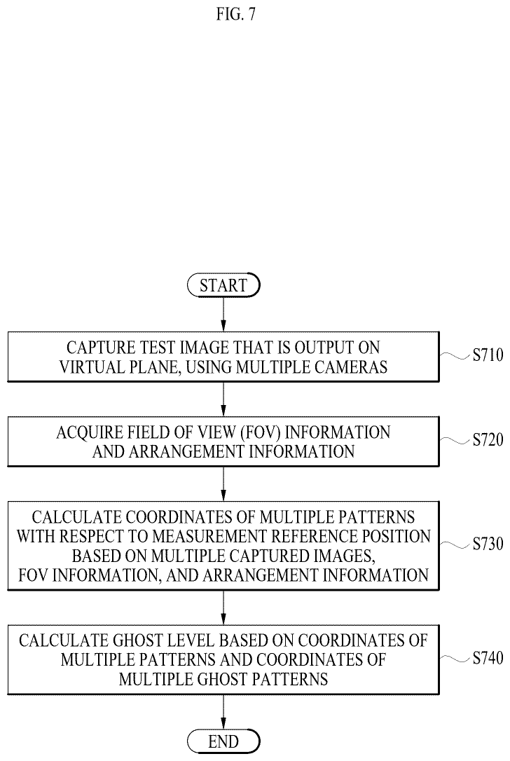

FIG. 7 is a flowchart showing a method of calculating a ghosting level according to an exemplary embodiment of the present disclosure.

In operation S710, the apparatus for measuring optical characteristics captures a test image including a plurality of patterns that is output in a virtual plane by the augmented reality (AR) device, using at least one camera disposed around a predetermined measurement reference position.

In operation S720, the apparatus for measuring optical characteristics acquires field of view (FOV) information including information about the field of view (FOV) of the at least one camera, and arrangement information including information about the arrangement of the at least one camera.

In operation S730, the apparatus for measuring optical characteristics calculates the coordinates of a plurality of patterns and the coordinates of a plurality of ghost patterns with respect to the measurement reference position on the basis of a plurality of images captured by the at least one camera, field of view (FOV) information, and arrangement information.

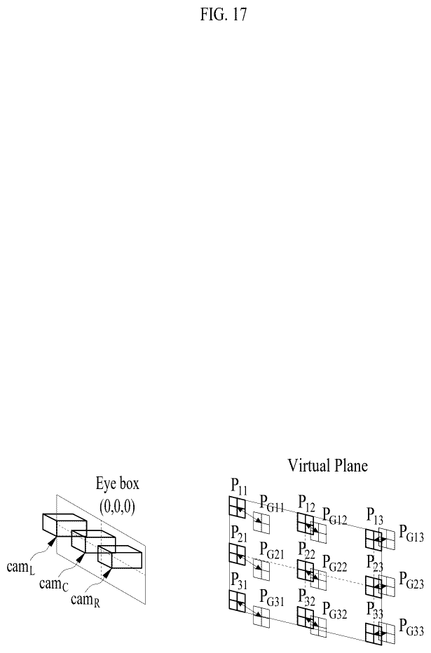

For example, a ghost pattern may be generated on an automotive windshield that transmits a half of input light and reflects the other half. In more detail, referring to FIG. 17, two physical layers of a windshield cause a ghost phenomenon, so that a pattern in a virtual plane and a ghost pattern corresponding to the pattern may appear to overlap, like double vision, or may appear blurry to a user.

In this case, the apparatus for measuring optical characteristics may calculate the coordinates of a plurality of ghost patterns corresponding to the coordinates of a plurality of patterns, respectively, in the same way as the method of calculating the coordinates of a plurality of patterns.

Finally, in operation S740, the apparatus for measuring optical characteristics may calculate ghosting levels on the basis of the coordinates of the plurality of patterns and the coordinates of the plurality of ghost patterns.

In this case, the apparatus for measuring optical characteristics may calculate a ghosting level from the gap between an original pattern and a corresponding ghost pattern.

In more detail, the apparatus for measuring optical characteristics may calculate a ghosting level, using Equation 8.

$$[ Equation 8 ]$$

$$Ghost = \frac{{\sum }_{i = 1}^{3} {\sum }_{j = 1}^{3} \sqrt{{( {x}_{i j} - {x}_{G i j} )}^{2} + {( {y}_{i j} - {y}_{G i j} )}^{2} + {( {z}_{i j} - {z}_{G i j} )}^{2}}}{9}$$

In Equation 8, Ghost is a ghosting level, xᵢⱼ, yᵢⱼ, and zᵢⱼ are the x, y, and z coordinates of a horizontal i-th (i=1, 2, 3) and vertical j-th (j=1, 2, 3) pattern, and x_{Gij}, y_{Gij}, and z_{Gij} are the x, y, and z coordinates of a horizontal i-th and vertical j-th ghost pattern.

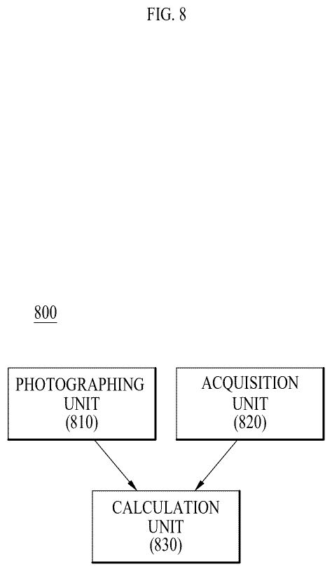

FIG. 8 is a block diagram showing the apparatus 800 for measuring optical characteristics of the augmented reality (AR) device according to an exemplary embodiment of the present disclosure.

Referring to FIG. 8, the apparatus 800 for measuring optical characteristics of the augmented reality (AR) device according to an exemplary embodiment of the present disclosure includes a photographing unit 810, an acquisition unit 820, and a calculation unit 830.

The photographing unit 810 captures a test image including a plurality of patterns that is output in a virtual plane by the augmented reality (AR) device, using at least one camera disposed around a predetermined measurement reference position.

The acquisition unit 820 acquires field of view (FOV) information including information about the field of view (FOV) of the at least one camera, and arrangement information including information about the arrangement of the at least one camera.

Finally, the calculation unit 830 calculates the coordinates of a plurality of patterns with respect to the measurement reference position on the basis of a plurality of images captured by the at least one camera, field of view (FOV) information, and arrangement information.

In another exemplary embodiment, the at least one camera is a central camera positioned at the measurement reference position, and a left camera and a right camera symmetrically positioned with the measurement reference position therebetween. When a plurality of patterns is horizontally and vertically arranged in one test image, the calculation unit 830 may calculate the coordinates of a plurality of patterns, using the number of horizontal pixels of a plurality of captured images, the coordinates of a plurality of patterns in the plurality of captured images, the field of view (FOV) of at least one camera included in field of view (FOV) information, and the distance between the left camera and the right camera included in the arrangement information.

In another exemplary embodiment, the calculation unit 830 may calculate the coordinates of a plurality of patterns, using Equation 9.

$${z}_{i j} = \frac{α}{2 \cdot tan \frac{θ}{2}} \cdot \frac{M}{( {m}_{i j}^{L} - {m}_{i j}^{R} )} \qquad [ Equation 9 ]$$

$${x}_{i j} = {z}_{i j} \cdot tan \frac{θ}{2} ( 2 \cdot \frac{{m}_{i j}^{c}}{M} - 1 )$$

$${y}_{i j} = {z}_{i j} \cdot tan \frac{θ}{2} ( 2 \cdot \frac{{n}_{i j}^{c}}{M} - 1 )$$

In Equation 9, xᵢⱼ, yᵢⱼ, and zᵢⱼ are x-axial, y-axial, and z-axial coordinates of the horizontal i-th and vertical j-th pattern with respect to the measurement reference position, α is the distance between the left camera and the right camera, M is the number of horizontal pixels of a plurality of captured images, θ is the field of view (FOV) of at least one camera,

$${m}_{ij}^{L}$$

is the horizontal coordinate of the horizontal i-th and vertical j-th pattern in the captured image of the left camera,

$${m}_{ij}^{R}$$

is the horizontal coordinate of the horizontal i-th and vertical j-th pattern in the captured image of the right camera, and

$${m}_{ij}^{c}$$

is the horizontal coordinate of the horizontal i-th and vertical j-th pattern in the captured image of the central camera.

In another exemplary embodiment, the calculation unit 830 may further calculate a virtual image distance between a measurement reference position and a virtual plane, using the coordinates of the measurement reference position and the coordinates of at least one of a plurality of patterns on the virtual plane.

In another exemplary embodiment, the calculation unit 830 may calculate a virtual image distance, using Equation 10.

$${D}_{VI} = \sqrt{{x}_{22}^{2} + {y}_{22}^{2} + {z}_{22}^{2}} \qquad [ Equation 10 ]$$

In Equation 10, D_{VI} is a virtual image distance, and x₂₂, y₂₂, and z₂₂ are the coordinates of one of a plurality of patterns.

In another exemplary embodiment, the calculation unit 830 may further calculate a look down/up angle from a measurement reference position to a virtual plane, using the coordinates of the measurement reference position and the coordinates of at least one of a plurality of patterns on the virtual plane.

In another exemplary embodiment, the calculation unit 830 may calculate look down/up angle, using Equation 11.

$${θ}_{down / up} = {cos}^{- 1} \frac{\sqrt{{x}_{22}^{2} + {z}_{22}^{2}}}{\sqrt{{x}_{22}^{2} + {y}_{22}^{2} + {z}_{22}^{2}}} \qquad [ Equation 11 ]$$

In Equation 11, θ_{down/up} is a look down/up angle, and x₂₂, y₂₂, and z₂₂ are the coordinates of one of a plurality of patterns.

In another exemplary embodiment, the calculation unit 830 may further calculate the horizontal field of view (FOV) of a measurement reference position, using the coordinates of the measurement reference position and the coordinates of two patterns positioned at both horizontal ends of a plurality of patterns in a virtual plane.

In another exemplary embodiment, the calculation unit 830 may calculate a horizontal field of view (FOV), using Equation 12.

$${θ}_{F O V}^{V} = {cos}^{- 1} \frac{{‖ \overline{{P}_{12} O} ‖}^{2} + {‖ \overline{{P}_{32} O} ‖}^{2} - {‖ \overline{{P}_{12} {P}_{32}} ‖}^{2}}{2 \cdot ‖ \overline{{P}_{12} O} ‖ + ‖ \overline{{P}_{32} O} ‖} \qquad [ Equation 12 ]$$

In Equation 12,

$${θ}_{F O V}^{H}$$

is a horizontal field of view (FOV), O is the coordinate of a measurement reference position, and P₂₁ and P₂₃ are coordinates of two patterns positioned at both horizontal ends.

In another exemplary embodiment, the calculation unit 830 may further calculate the virtual field of view (FOV) of a measurement reference position, using the coordinates of the measurement reference position and the coordinates of two patterns positioned at both virtual ends of a plurality of patterns in a virtual plane.

In another exemplary embodiment, the calculation unit 830 may calculate a virtual field of view (FOV), using Equation 13.

$${θ}_{F O V}^{V} = {cos}^{- 1} \frac{{‖ \overline{{P}_{12} O} ‖}^{2} + {‖ \overline{{P}_{32} O} ‖}^{2} - {‖ \overline{{P}_{12} {P}_{32}} ‖}^{2}}{2 \cdot ‖ \overline{{P}_{12} O} ‖ + ‖ \overline{{P}_{32} O} ‖} \qquad [ Equation 13 ]$$

In Equation 13,

$${θ}_{F O V}^{V}$$

is a vertical field of view (FOV), O is the coordinate of a measurement reference position, and P₁₂ and P₃₂ are coordinates of two patterns positioned at both vertical ends.

In another exemplary embodiment, the calculation unit 830 may further calculate a static distortion for each of three axes with respect to a measurement reference position on the basis of the coordinates of a plurality of patterns in a virtual plane.

In another exemplary embodiment, the calculation unit 830 may further calculate the coordinates of a plurality of ghost patterns corresponding to the coordinates of a plurality of patterns, respectively, on the basis of a plurality of captured images, field of view (FOV) information, and arrangement information, and may further calculate ghosting levels on the basis of the coordinates of the plurality of patterns and the coordinates of the plurality of ghost patterns.

Meanwhile, the exemplary embodiments of the present disclosure described above may be written as programs that can be executed in a computer and may be implemented in a common digital computer that executes the programs using a computer-readable recording medium.

The computer-readable recording medium includes a magnetic storage medium (e.g., a ROM, a floppy disk, and a hard disk) and an optical reading medium (e.g., a CD-ROM and a DVD).

Preferred exemplary embodiments of the present disclosure have been described. It would be understood by those skilled in the art that the present disclosure may be modified without departing from the scope of the present disclosure. Therefore, the disclosed exemplary embodiments should be considered in terms of explaining, not limiting. The scope of the present disclosure is defined by the claims, not the above description, and all differences within an equivalent range should be construed as being included in the present disclosure.

Referring to FIGS. 9 and 10, a camera according to the embodiments may correspond to a light measurement device (LMD). The light measurement device according to the embodiments may generate a virtual image plane and generate an image including patterns at different positions. The method for measuring optical characteristics according to the embodiments may include generating images including points in each pattern for a virtual image plane using one or more light measurement devices (LMDs), wherein each image is captured based on the one or more light measurement devices (LMDs) and each image corresponds to at least one of a left image, a central image, and a right image. The method for measuring the optical characteristics may further include: generating positions of points based on the one or more light measurement devices (LMDs) and each pattern; wherein the positions may be obtained based on a field of view (FOV) of the one or more light measurement devices (LMDs), and a gap between the left light measurement device (LMD) and the right light measurement device (LMD).

Referring to FIG. 10, one LMD may capture three images for a virtual plane at the center, left, and right positions, and multiple LMDs may capture three images for a virtual plane at the center, left, and right positions.

Referring to FIG. 12, the positions of the points may be estimated based on, for example, the capture angle for the left LMD position and the capture angle for the right LMD position.

Based on Equation 1, the coordinate values of the positions for the pattern of the image may be calculated.

Referring to Equation 1, according to the optical characteristic measurement method/apparatus according to the embodiments, the left image including the points in the pattern may be captured based on the left optical measurement device of one or more optical measurement devices, the central image including the points in the pattern may be captured based on the central optical measurement device of one or more optical measurement devices, and the right image including the points in the pattern may be captured based on the right optical measurement device of one or more optical measurement devices. The index according to the embodiments may indicate the order of such capture, and the field of view (FOV) may correspond to the angle of view.

Referring to FIG. 13 and Equation 2, the coordinate values of the position may be calculated based on the horizontal pixel index of the left optical measurement device, the horizontal pixel index of the right optical measurement device, the horizontal pixel index of the central optical measurement device, and the field of view (FOV) of the left optical measurement device.

Referring to FIG. 14 and Equation 4, the optical characteristic measurement method according to the embodiments may further include measuring a virtual image distance for a virtual image plane based on the position within the pattern and the optical measurement device in the central image.

Referring to FIG. 15, the method may further include measuring a look down angle and a look up angle for the virtual image plane based on the position within the pattern and the virtual image distance.

Referring to FIG. 16, the method may further include: measuring a horizontal field of view (FOV) for a virtual image plane based on a distance to a left point in the center region and a distance to a right point in the center region; and measuring a vertical field of view (FOV) for the virtual image plane based on a distance to a top point in the center region and a distance to a bottom point in the center region.

The optical characteristic measurement method according to the embodiments may further include: measuring a horizontal distortion for the virtual image plane based on a line connecting the center point, the top point in the center region and the bottom point in the center region; and measuring a vertical distortion for the virtual image plane based on a line connecting the center point, the left point in the center region and the right point in the center region.

The optical characteristic measurement method/device according to the embodiments may be referred to as a method/device according to the embodiments.

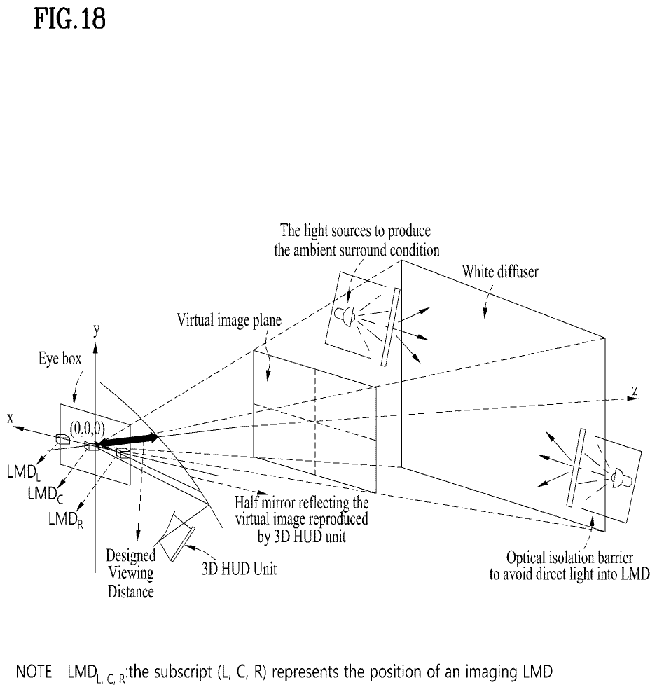

FIG. 18 illustrates a measurement configuration for image quality characteristics of a virtual image type 3D display such as a 3D HUD according to the embodiments of the present disclosure.

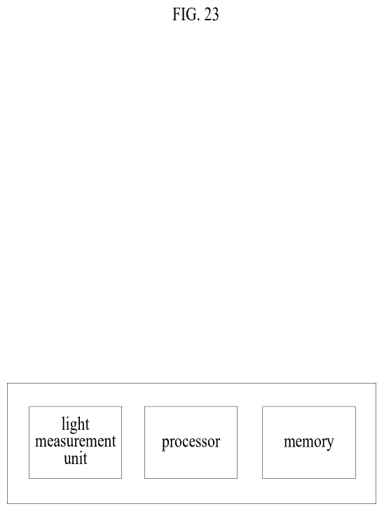

The optical characteristic measurement device according to the embodiments of FIGS. 8 and 23 may measure the optical characteristics of a virtual image with a structure such as FIG. 18.

The method/device according to the embodiments may include the following configuration for measuring image quality characteristics.

Referring to FIG. 18, the geometric relationship between the eye box, the virtual image, and the white diffuser can be seen.

When the user's eyes are positioned in the eye box, it is assumed that the user can see the entire virtual image through natural movement of the eyes. The eye box position may be specified by the supplier. Otherwise, it may be estimated according to the method provided in IEC 62629-62-11 (see especially 4.2.3). The measurement device of the imaging LMD may be set within the eye-box position. A 3D image may be provided on the front or back surface in the virtual image plane. The 3D coordinate system of xyz shown in FIG. 18 is defined to determine the position of the 3D image and the virtual image plane from the user's eyes.

Referring to FIG. 18, the designed viewing distance is the distance between the center of the eye box and the position of the half mirror, and may be determined and provided by the supplier. At this distance, the proper view may be observed or the image quality characteristics of the virtual image reproduced by the autostereoscopic 3D display are accurately measured. For the measurement, the viewing distance can be applied as the measurement distance. The measurement distance may be fixed when measuring the item to be evaluated.

The configuration and conditions for measurement of the contrast and color of the 3D virtual overlay under the surrounding environment conditions are as follows.

Various virtual image content such as numbers, characters (letters), and other symbols may be reproduced as a 3D display in the form of a virtual image such as a 3D HUD. In general, a clear 3D virtual image can be displayed for the real environment. In order to evaluate the image quality from this perspective, the contrast and color-related attributes should be measured for the 3D virtual image overlapping the real environment.

However, the real environment is very diverse. Compared to the real objects adjacent to each other, the background effect, where the color and brightness characteristics of the 3D virtual image appear different from those of the adjacent real objects, is a visual recognition problem, and thus is excluded from this criterion. In order to improve visibility, brightness of the 3D virtual image may be controlled according to a predetermined algorithm embedded in the 3D HUD according to a change in the illuminance level of the real environment. Therefore, a measurement method is proposed to evaluate a change in contrast (reflecting a change in black-and-white brightness) and a change in chromaticity of the 3D virtual image under various ambient conditions. The illuminance level and the correlated color temperature for the ambient conditions can be referenced.

The room where the measurement is performed is a completely dark room. The white diffuser is located behind the virtual image plane with a size larger than each of the horizontal and vertical FOVs of the virtual image plane. Since the entire virtual plane can be observed when the user's eye is inside the eyebox, the white diffuser screen size can also be large enough to overlap the entire virtual plane if there is a light measurement device (LMD) inside the eyebox.

The illuminance and correlated color temperature of the ambient conditions are measured at the center of the white diffuser. The luminance reflected by the white diffuser is measured with zero input applied to the display to be measured. This measurement value is evaluated for the presence of stray light.

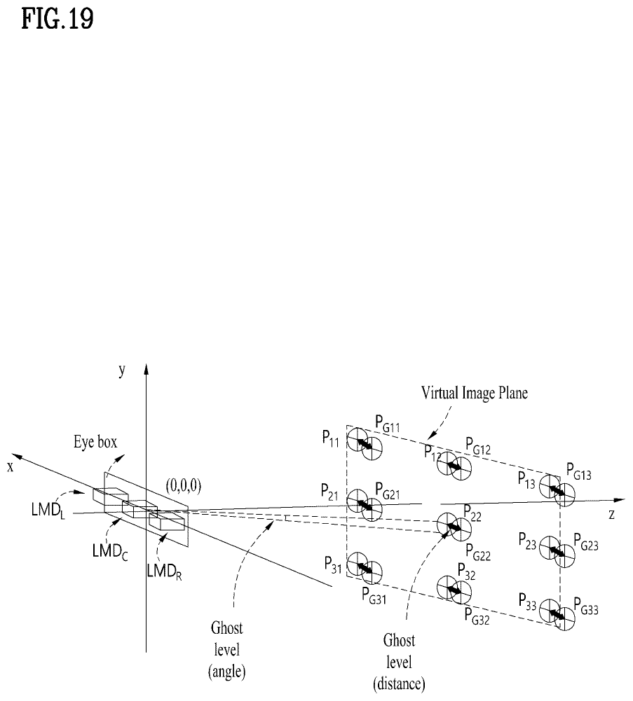

FIG. 19 shows a measurement method for a ghost image according to the embodiments of the present disclosure.

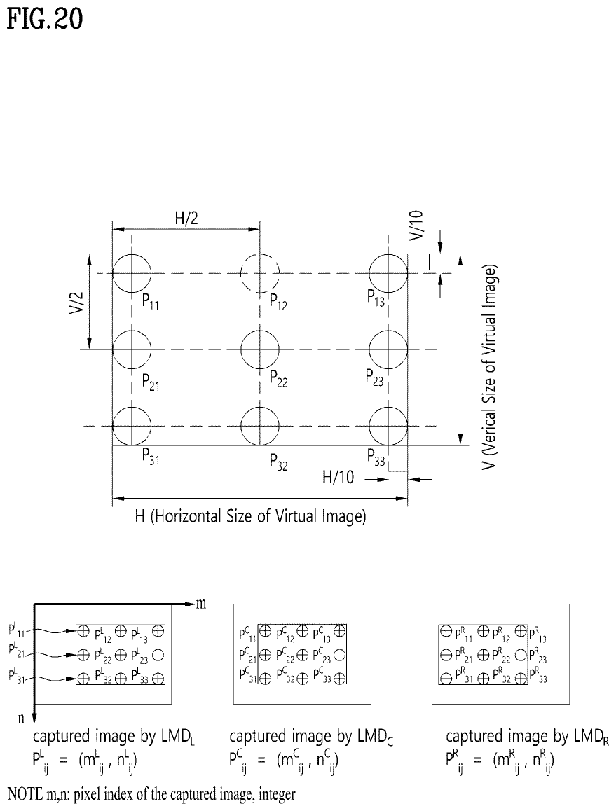

FIG. 20 shows a test image with nine measurement points and three corresponding images captured by LMDs according to the embodiments of the present disclosure.

The optical characteristic measurement device according to the embodiments of FIGS. 8 and 23 may measure optical characteristics based on the above-described embodiments and/or the method described in FIG. 18 and below. Specifically, the optical characteristic measurement device may generate measurement values for a ghost image related to the HUD.

The 3D virtual image may be generated through a process of reflection and magnification through the half mirror and optical system of the 3D HUD of FIG. 18. The certain amount of light reaching the mirror may be reflected and the remaining light is transmitted outside the mirror inside the half mirror, such as the windshield of FIG. 18. The two physical layers of the windshield cause a ghost image that appears as a double image with shadows and outlines. The ghosting level may be measured at the gap between the original pattern and the second pattern.

Conditions for the measurement method according to the embodiments are as follows:
a) test pattern: test image with nine circles in FIG. 20
b) test signal: nine circles consisting of a black border and a central cross against a completely white background
c) neighboring dark surround condition; and
d) test pattern image acquisition: three imaging LMDs in the eye box are used to capture three sets of 2D images, the left, center, and right images of FIG. 19.

The flowchart of the measurement method according to the embodiments includes the following a), b), c), and d) steps.

In step (a), a test signal is applied to the measurement device.

In step (b), three test pattern images are acquired by three imaging LMDs (i.e., LMD(L), LMD(C) and LMD(R)) shown in FIG. 19.

In step (c), all positions (xᵢⱼ, yᵢⱼ, zᵢⱼ) ij=1, 2, 3 for P11 to P33 of the original test pattern and ghost patterns for corresponding positions (x_{Gij}, y_{Gij}, z_{Gij}) ij=1, 2, 3 for PG11 to PG33 are determined according to the procedure described above.

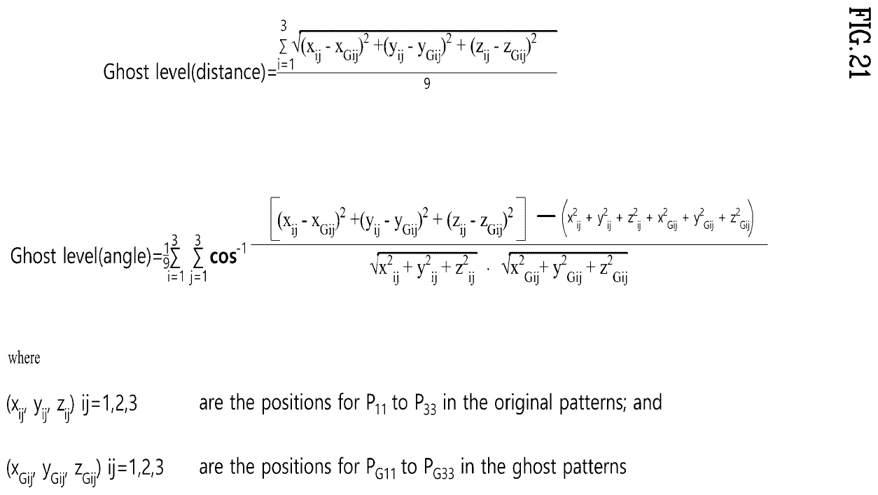

In step (d), the level of the ghost image is calculated as the average of the distances or angles between the original image and the corresponding positions for P11 to P33 as shown in FIG. 21.

FIG. 21 shows a method for obtaining a ghost level for a ghost image according to the embodiments of the present disclosure.

The method/device according to the embodiments may generate a ghost level (distance) and a ghost level (angle) based on a difference value between the positions of the test pattern and the positions of the ghost patterns of the ghost image, as shown in FIG. 21, according to the flowchart shown in FIG. 20.

Optical measurement actions related to the ghost image according to the embodiments can be performed based on the levels obtained as described above.

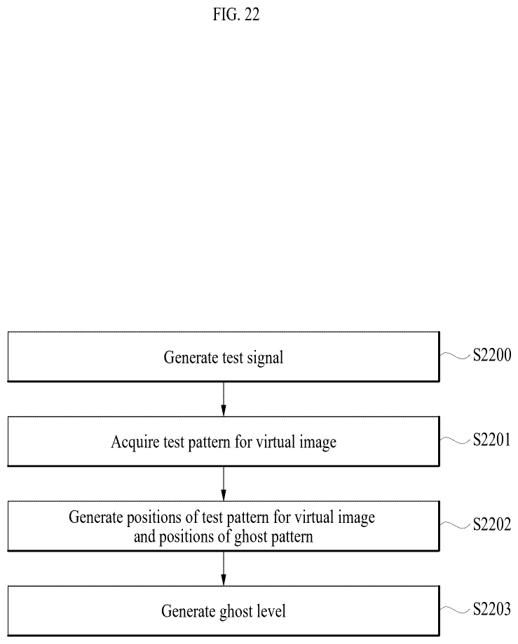

FIG. 22 is a flowchart illustrating the method for measuring the optical characteristics according to the embodiments of the present disclosure.

The method for measuring the optical characteristics according to the embodiments may include the following flowchart as shown in FIG. 22.

In operation S2200, the optical measurement method according to the embodiment may include generating a test signal.

In operation S2201, the optical measurement method according to the embodiments may further include acquiring a test pattern for a virtual image.

In operation S2202, the optical measurement method according to the embodiments may further include generating positions of a test pattern for a virtual image and positions of a ghost pattern. The method of generating the positions has been described above with reference to FIGS. 1 to 17.

In operation S2203, the optical measurement method according to the embodiments may further include generating a ghost level. The method of obtaining the ghost level has been described above with reference to FIGS. 18 to 21.

FIG. 23 is a block diagram illustrating the optical measurement device according to embodiments of the present disclosure.

The method according to the embodiments may be performed by the device of FIG. 23. Each component of FIG. 23 may correspond to hardware, software, a processor, and/or a combination thereof. FIG. 23 may correspond to the device of FIG. 8.

The optical measurement unit may be a camera. The processor may be a processor that performs operations according to the embodiments. The memory may store data and information related to the operation of the processor. The memory may provide necessary data to the processor. The memory may be connected to the optical measurement unit, the processor, etc.

With respect to ghost level measurement, referring to the drawings described above, the method according to the embodiments may further include: generating images including points in each pattern for a virtual image plane using one or more optical measurement devices, wherein each image is captured based on the one or more optical measurement devices, and each image corresponds to at least one of a left image, a central image, and a right image. The method may further include: generating positions of points based on one or more optical measurement devices and each pattern; and generating a level for a ghost image for the virtual image plane based on the generated positions, wherein the positions can be obtained based on a field of view (FOV) of the one or more optical measurement devices, a gap between the left optical measurement device and the right optical measurement device.

In addition, the step of generating a level for the ghost image may include generating a test signal; generating positions of a test pattern of a virtual image for the test signal and positions of a ghost pattern for the positions; and generating a ghost level based on the positions of the test pattern and the positions of the ghost pattern.

In addition, the ghost level may be obtained based on the average of distances between the positions of the test pattern and the positions of the ghost pattern and the average of angles between the positions of the test pattern and the positions of the ghost pattern.

The method according to the embodiments may be performed by the device. The device according to the embodiments may include a photographing unit that generates images including points in each pattern for a virtual image plane using one or more optical measurement devices, each image being captured based on the one or more optical measurement devices, and each image corresponding to at least one of a left image, a central image, and a right image; and a calculation unit that generates positions of points based on the one or more optical measurement devices and each pattern. The calculation unit may generate a level for a ghost image for the virtual image plane based on the generated positions, and the positions may be obtained based on a field of view (FOV) of the one or more optical measurement devices, and a gap between the left optical measurement device and the right optical measurement device. Each component of the device may include an interface for transmitting and receiving signals, a memory for storing operation-related information, and a processor for controlling the operation. The operations of the photographing unit and the calculation unit may be performed by the processor.

In addition, the processor may perform a step of generating a test signal, a step of generating positions of a test pattern of a virtual image for the test signal and positions of a ghost pattern for the positions, and a step of generating a ghost level based on the positions of the test pattern and the positions of the ghost pattern.

In addition, the ghost level may be obtained based on the average of distances of the positions of the test pattern and distances of the positions of the ghost pattern, and the average of angles of the positions of the test pattern and the positions of the ghost pattern.

As a result, the 3D HUD vehicle service can be improved in terms of driver visibility and convenience. In addition, since a light measurement device is mounted on the vehicle, measurement parameters for measuring optical characteristics such as points and depth for a HUD virtual image can be efficiently obtained. Based on the obtained parameter information, a calibration process that can reduce errors from the driver's perspective can be efficiently performed. The 3D HUD can be combined with autonomous driving technology to enable safe and accurate autonomous driving. In addition, accurate and safe vehicle services can be provided to the driver by processing ghost images.

Embodiments have been described from the method and/or device perspective, and descriptions of methods and devices may be applied so as to complement each other.

Although the accompanying drawings have been described separately for simplicity, it is possible to design new embodiments by merging the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this specification, the term “/“and”,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or a combination thereof. The firmware, software, and/or a combination thereof may be stored in the processor or the memory.

The operations according to the above-described embodiments may be performed by the transmission device and/or the reception device according to the embodiments. The transmission/reception device includes a transmitter/receiver configured to transmit and receive media data, a memory configured to store instructions (program code, algorithms, flowcharts and/or data) for a process according to embodiments, and a processor configured to control operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

As described above, related contents have been described in the best mode for carrying out the embodiments.

### INDUSTRIAL APPLICABILITY

As described above, the embodiments may be fully or partially applied to the method and device for measuring the HUD ghost image.

It will be apparent to those skilled in the art that various changes or modifications can be made to the embodiments within the scope of the embodiments.

Thus, it is intended that the embodiments cover the modifications and variations of this disclosure provided they come within the scope of the appended claims and their equivalents.

What is claimed is:

1. A method for measuring optical characteristics comprising:
generating images including points in each pattern for a virtual image plane using one or more optical measurement devices, wherein each image is captured based on the one or more optical measurement devices, and each image corresponds to at least one of a left image, a central image, and a right image; and
generating positions of the points based on the one or more optical measurement devices and each pattern; and
generating a level for at least one ghost image for the virtual image plane based on the generated positions,
wherein
the positions are obtained based on a field of view (FOV) of the one or more optical measurement devices, and a gap between a left optical measurement device and a right optical measurement device.

2. The method according to claim 1, wherein:
the left image including points in a pattern is captured based on the left optical measurement device of the one or more optical measurement devices;
the central image including points in a pattern is captured based on a central optical measurement device of the one or more optical measurement devices; and
the right image including points in a pattern is captured based on the right optical measurement device of the one or more optical measurement devices.

3. The method according to claim 1, wherein:
coordinate values of the positions are calculated based on a horizontal pixel index of the left optical measurement device, a horizontal pixel index of the right optical measurement device, a horizontal pixel index of the central optical measurement device, and a field of view (FOV) of the left optical measurement device.

4. The method according to claim 1, further comprising:
measuring a virtual image distance for the virtual image plane based on a position within the pattern in a center region and the optical measurement device.

5. The method according to claim 4, further comprising:
measuring a look-down angle and a look-up angle for the virtual image plane based on the position within the pattern and the virtual image distance.

6. The method according to claim 1, further comprising:
measuring a horizontal field of view (FOV) for the virtual image plane based on a distance to a left point of a center region and a distance to a right point of the center region; and
measuring a vertical field of view (FOV) for the virtual image plane based on a distance to a top point of the center region and a distance to a bottom point of the center region.

7. The method according to claim 1, further comprising:
measuring a horizontal distortion for the virtual image plane based on a line connecting a center region, a top point of the center region, and a bottom point of the center region; and
measuring a vertical distortion for the virtual image plane based on a line connecting the center region, a left point of the center region and a right point of the center region.

8. The method according to claim 1, wherein the generating the level for the ghost image includes:
generating a test signal,
generating positions of a test pattern of a virtual image for the test signal and positions of a ghost pattern for the positions; and
generating a ghost level based on the positions of the test pattern and the positions of the ghost pattern.

9. The method according to claim 8, wherein:
the ghost level is obtained based on an average of distances between positions of the test pattern and positions of the ghost pattern and an average of angles between the positions of the test pattern and the positions of the ghost pattern.

10. A device for measuring optical characteristics comprising:
a photographing unit configured to generate images including points in each pattern for a virtual image plane using one or more optical measurement devices, wherein each image is captured based on the one or more optical measurement devices, and each image corresponds to at least one of a left image, a central image, and a right image; and
a calculation unit configured to generate positions of the points based on the one or more optical measurement devices and each pattern, and generate a level for at least one ghost image for the virtual image plane based on the generated positions,
wherein
the positions are obtained based on a field of view (FOV) of the one or more optical measurement devices, and a gap between a left optical measurement device and a right optical measurement device.

11. The device according to claim 10, wherein:
the left image including points in a pattern is captured based on the left optical measurement device of the one or more optical measurement devices;
the central image including points in a pattern is captured based on a central optical measurement device of the one or more optical measurement devices; and
the right image including points in a pattern is captured based on the right optical measurement device of the one or more optical measurement devices.

12. The device according to claim 10, wherein:
coordinate values of the positions are calculated based on a horizontal pixel index of the left optical measurement device, a horizontal pixel index of the right optical measurement device, a horizontal pixel index of the central optical measurement device, and a field of view (FOV) of the left optical measurement device.

13. The device according to claim 10, wherein the calculation unit is configured to:
measure a virtual image distance for the virtual image plane based on a position within the pattern in a center region and the optical measurement device.

14. The device according to claim 13, wherein the calculation unit is configured to:
measure a look-down angle and a look-up angle for the virtual image plane based on the position within the pattern and the virtual image distance.

15. The device according to claim 10, wherein the calculation unit is configured to:
measure a horizontal field of view (FOV) for the virtual image plane based on a distance to a left point of a center region and a distance to a right point of the center region; and
measure a vertical field of view (FOV) for the virtual image plane based on a distance to a top point of the center region and a distance to a bottom point of the center region.

16. The device according to claim 10, wherein the calculation unit is configured to:
measure a horizontal distortion for the virtual image plane based on a line connecting a center region, a top point of the center region, and a bottom point of the center region; and
measure a vertical distortion for the virtual image plane based on a line connecting the center region, a left point of the center region and a right point of the center region.

17. The device according to claim 10, wherein the calculation unit is configured to:
generate a test signal,
generate positions of a test pattern of a virtual image for the test signal and positions of a ghost pattern for the positions; and
generate a ghost level based on the positions of the test pattern and the positions of the ghost pattern.

18. The device according to claim 17, wherein:
the ghost level is obtained based on an average of distances between positions of the test pattern and positions of the ghost pattern and an average of angles between the positions of the test pattern and the positions of the ghost pattern.
